(19) United States
(12) Patent Application Publication
(10) Pub. No.: US 2006/0225329 A1
(43) Pub. Date: Oct. 12, 2006

(54) Vehicle convoy indicator

(76) Inventor: Lisa Ann Morrow, Columbia, MD (US)

Correspondence Address: William S. Ramsey, 5253 Even Star Place, Columbia, MD, 21044, US

(21) Appl. No.: 11/084,363

(22) Filed: Mar. 19, 2005

(51) Int. Cl. G09F 21/04

(52) U.S. Cl. 40/591

(57) ABSTRACT

Indicators of this invention show the existence of a convoy of vehicles and the position of a vehicle in the convoy. Safety on the highway is improved for both the convoy and non-convoy vehicles. The ability of convoy vehicles to maintain position in the convoy is improved by the use of indicators. A variety of indicators may be used, such as flags, magnetic signs, projected images, illuminated signs, window decals, or beacons.

### CROSS-REFERENCE TO RELATED APPLICATIONS

Not Applicable.

### STATEMENT REGARDING FEDERALLY SPONSORED RESEARCH OR DEVELOPMENT.

Not Applicable.

Reference to a “Microfiche appendix.”

Not Applicable.

### BACKGROUND OF THE INVENTION

1. Field of the Invention

This invention pertains to apparatus for signaling vehicles on a road of a potentially hazardous traffic condition associated with other vehicles.

2. Description of Related Art Including Information Disclosed Under 37 CFR 1.97 and 37 CFR 1.98.

Vehicles which are following another in convoy often are driven in ways which might incur hazards, especially when on a congested highway. This invention improves safety on the highway by indicators on the front, rear, or side of vehicles in convoy which indicate whether the vehicle is leading or following other vehicles in a convoy.

U.S. Pat. No. 3,854,438 discloses a system to indicate to a following vehicle the application of brakes by the vehicle ahead of the vehicle directly in front of the following vehicle. The middle vehicle has a light transmitting lens on the front of the vehicle, a light conduit along the length of the vehicle, and a light emitting lens at the rear.

U.S. Pat. No. 4,607,444 discloses a portable illumination sign with lights which spell out a message.

U.S. Pat. No. 5,463,974 discloses a mount for a flag or display for use with a parade or motorcade.

U.S. Pat. No. 5,590,621 discloses a flag which attaches to a radio antenna and is used for a funeral procession motorcade safety flag. Use of the flag avoids disruption of the procession causing great distress to grieving family of the deceased and to the mourning friends.

U.S. Pat. No. 5,905,434 discloses a vehicle communication device which displaces a variety of messages from the back or front of the vehicle. Messages are sent to the display from a RF sending unit.

U.S. Pat. No. 6,010,107 discloses a holder for signs, banners flags which fits on the top of a window. The flags may be used to designate cars in funeral processions.

U.S. Pat. No. 6,609,476 discloses flags which attach to a radio antenna and which are also used to designate cars as being part of a funeral procession or some other type of parade or procession.

U.S. Pat. No. 6,733,134 discloses a visual signaling device which projects a laser generated image on the payment at the front or rear of the vehicle. The nature of the image may be modified by signals from the roadway berm.

US Pub. Pat. Applic. No. US2003/0136327 discloses tires with strips of high contrast color on the tire tread which provides visual clues to the deceleration or acceleration during stop and go traffic.

None of the discovered prior art provides the advantages of this invention, that of enhancing highway safety by informing both approaching and following vehicles of a convoy of vehicles, one following another.

### BRIEF SUMMARY OF THE EMBODIMENTS OF THE INVENTION

Embodiments of the invention include a system for indicating the status of a vehicle on the road with respect to its place in a convoy comprising an indicator that is visible from the roof, front, rear, or side of the vehicle, the indicator warning of the existence of the convoy and indicating the position of the vehicle in the convoy.

Other embodiments of the invention include a system for indicating the status of a vehicle on the road with respect to its place in a convoy comprising a first indicator that is visible from the front of the leading vehicle in the convoy, the first indicator warning of following vehicles in the convoy and showing the status of the vehicle as the leading vehicle in the convoy. A second indicator is visible from the side of a vehicle intermediate in the convoy, the second indicator warning of the existence of the convoy and showing the status of the vehicle as an intermediate vehicle in the convoy. A third indicator is visible from the rear of the terminal vehicle in the convoy, the third indicator warning of the existence of the convoy and showing the status of the vehicle as the terminal vehicle in the convoy.

Convoy identification provides enhanced safety to both the vehicles in a convoy and other vehicles sharing the highway. A driver who is part of a convoy often finds it difficult to be sure that the proceeding vehicle is indeed the one which should be followed, especially after dark.

A vehicle following a convoy will thereby be notified that the proceeding vehicles may be closer to each other than non-convoyed vehicles, with implications for an overtaking vehicle. This is especially important on two-lane highways. On a multilane-highway the leading vehicle of a convoy may change several lanes in order to reach an off-ramp. This will result in an extended line of convoy vehicles also changing several lanes, with obvious safety implications. When a convoy approaches a traffic light, the first few vehicles may make it though the intersection before the light changes. The leading vehicles typically will then pull over to the right side of the highway while waiting for the remaining vehicles, whereupon the intact convoy will proceed. Non-convoyed vehicles will be better able to react to these maneuvers if there is some visible indicator of the existence of the convoy. Finally, there is a natural tendency of convoyed vehicles to travel with less than a safe distance between the vehicles. The clear identification of each vehicle in the convoy will allow travel at a safe interval.

One objective of embodiments of the invention is to provide a system which warns of the existence of a convoy of vehicles.

Another objective of embodiments of the invention is to provide a system which assists participants in a convoy in identifying other participants.

Another objective of embodiments of the invention is to provide a system which indicates-the position of a vehicle in a convoy.

Another objective of embodiments of the invention is to provide a system which maintains the integrity of a convoy of vehicles.

Another objective of embodiments of the invention is to provide a system which reduces the incidence of infringing upon a convoy of vehicles by non-convoy vehicles.

Another objective of embodiments of the invention is to provide a system which conveys particular information from vehicles in a convoy to other vehicles on the road.

Another objective of embodiments of the invention is to provide a system which may be manufactured inexpensively of readily available materials without adverse effect on the environment.

### BRIEF DESCRIPTION OF THE SEVERAL VIEWS OF THE DRAWINGS

FIG. 1 diagrammatically depicts a convoy of three vehicles.

FIG. 2 is a plan view of a magnetic sign embodiment.

FIG. 3 is a plan view of a second magnetic sign embodiment.

FIG. 4 is a plan view of a third magnetic sign embodiment.

FIG. 5 is a plan view of a flag embodiment.

FIG. 6 is a plan view of an inside the vehicle embodiment.

FIG. 7 is a perspective view of a projector image embodiment.

FIG. 8A, 8B, and 8C are plan views of an illuminated sign embodiment.

FIG. 9 is a perspective view of an illuminated beacon embodiment.

### DETAILED DESCRIPTION OF THE EMBODIMENTS OF THE INVENTION

In this patent application, the term “convoy” refers to two or more vehicles traveling together on a roadway. Such a procession, also sometimes called a caravan, is often created by travelers in more than one vehicle in order to provide mutual assistance in the event of breakdown or accident, and more commonly, to provide guidance when the drivers of fewer than all of the vehicles are familiar with the route from a starting site to a common destination. This is especially important in bringing a number of vehicles through congested high-speed highways, for example, on interstate highways associated with large cities. Finally, convoys also are involved in processions from the site of a funeral to the site of internment.

Convoy identification provides enhanced safety to both the vehicles in a convoy and other vehicles sharing the highway. A vehicle following a convoy will thereby be notified that the proceeding vehicles may be closer to each other than non-convoyed vehicles, with implications for an overtaking vehicle.

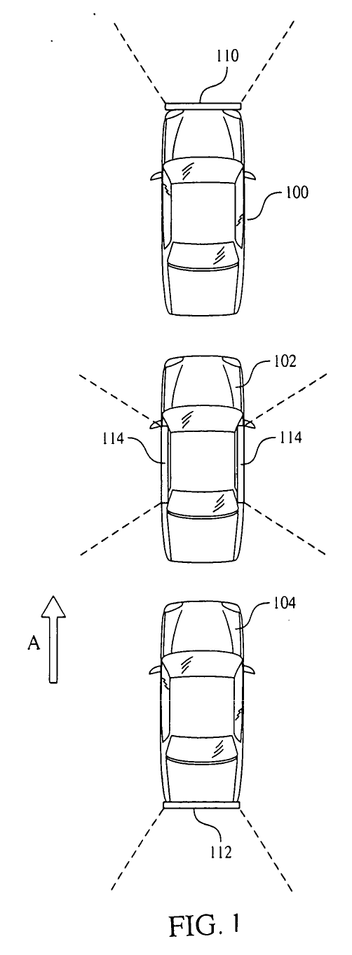

FIG. 1 diagrammatically depicts a convoy of three vehicles traveling in the direction indicated by arrow A. The leading vehicle 100 has visible from the front of the vehicle a front indicator 110 which indicates to approaching vehicles that a convoy is on the road and that vehicle 100 is the leading the convoy. Intermediate vehicle 102 has visible from the side or sides of the vehicle a side indicator 114 which indicates to overtaking vehicles that a convoy is on the road and that vehicle 102 is a member of the convoy. Any number of vehicles may be included in a convoy. Terminal vehicle 104 has visible from the back of the vehicle a rear indicator 112 which indicates to vehicles approaching the convoy from the rear that a convoy is on the road and that vehicle 104 is the terminal vehicle of that convoy. Optionally, vehicles 100 or 102 may also have rear indicator 112. In FIG. 1, the dashed lines at vehicle 100, 102, and 104 indicate the visibility of the indicators at the front, side, and rear of the convoy, respectively.

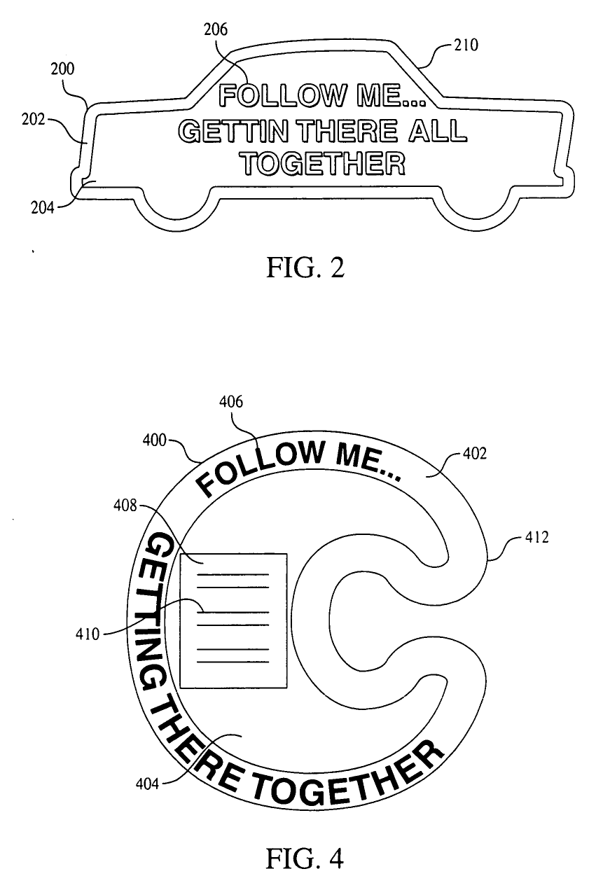

FIG. 2 is a plan view of a magnetic sign embodiment 200. The convoy sign has a characteristic shape 210, in this embodiment, that of the outline of a car. A border 202 is of a color which contrasts strongly with the background color 204. Indicia “FOLLOW ME . . . GETTING THERE ALL TOGETHER” 206 emphasizes the function of the magnetic sign embodiment in indicating the existence of a convoy and the participation of the vehicle which bears the sign in the convoy. Magnetic signs are constructed of flexible magnetic material with a polymer surface which will accept bright colors. They are removably attached to steel or iron surfaces such as vehicle doors.

FIG. 3 is a plan view of a second magnetic sign embodiment 300. The convoy sign has a characteristic shape 312, in this embodiment, that of a stylized car outline. A border 302 is of a color which contrasts strongly with the background color 304. Indicia “CONVOY IN PROGRESS” 306 emphasizes the function of the magnetic sign embodiment in indicating the existence of a convoy and the participation of the vehicle which bears the sign in the convoy.

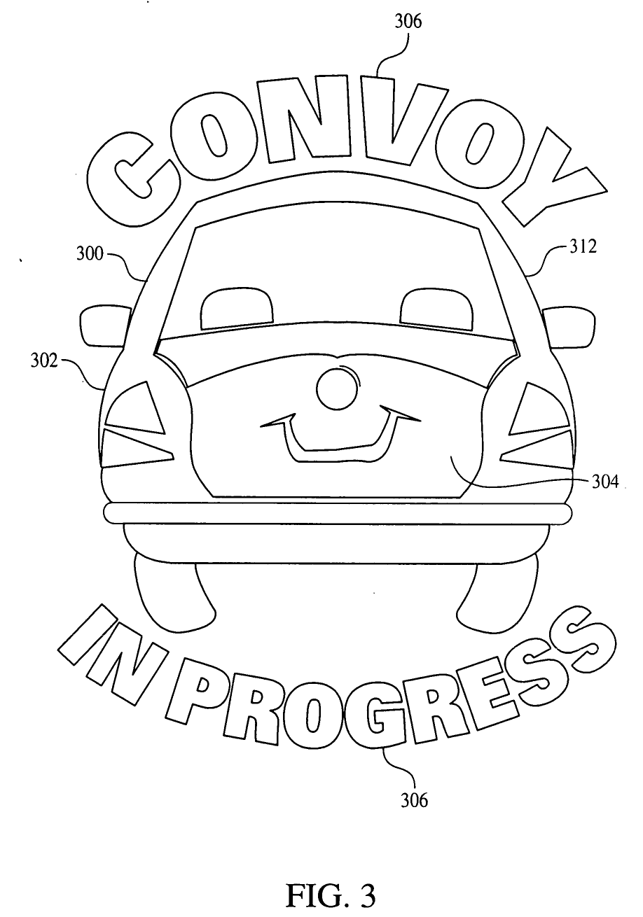

FIG. 4 is a plan view of a magnetic sign embodiment 400. The convoy sign has a characteristic shape 410, in this embodiment, that of a stylized letter C. A border 402 is of a color which contrasts strongly with the background color 404. Indicia 406 emphasizes the function of the magnetic sign embodiment in indicating the existence of a convoy and the participation of the vehicle which bears the sign in the convoy. This embodiment includes a pocket 408 which receives a sheet with indicia 410 with additional information for the participants of the convoy, such as the time for a meal break.

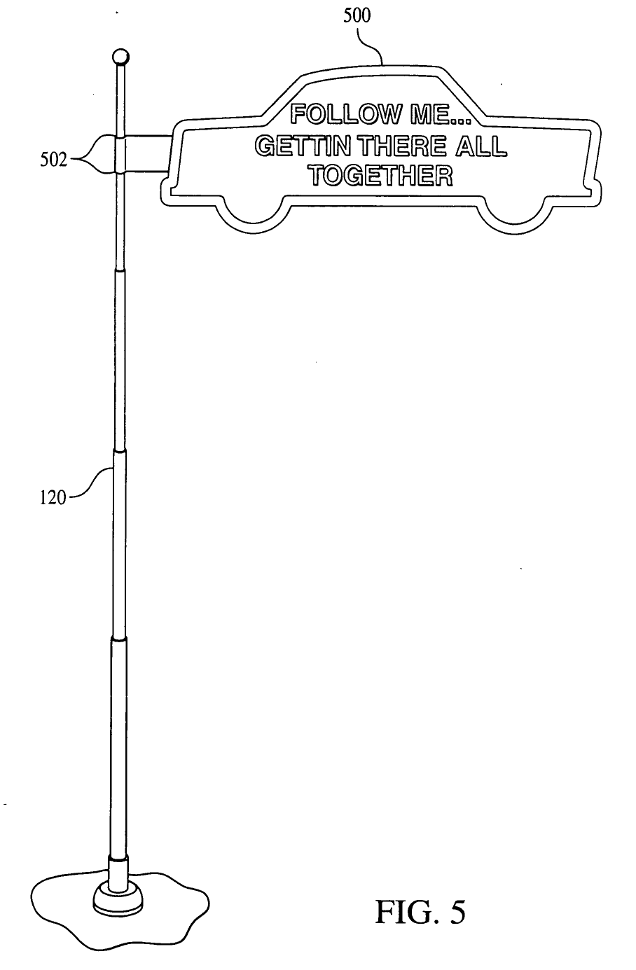

FIG. 5 is a plan view of a flag embodiment 500. The flag has the shape, colors, and indicia of the magnetic sign embodiments. Ties 502 are used to removably attach the flag to a radio antenna 120 on a vehicle in a convoy. Any suitable strong, flexible, durable fabric may be used for construction of the flag embodiment. Any suitable attachment devices which will reversibly yet securely attach the flag to an antenna may be used, such as clamps or rings. The attachment devices disclosed in U.S. Pat. Nos. 5,590,621 and 6,609,476, both incorporated herein by reference, may be used with this embodiment.

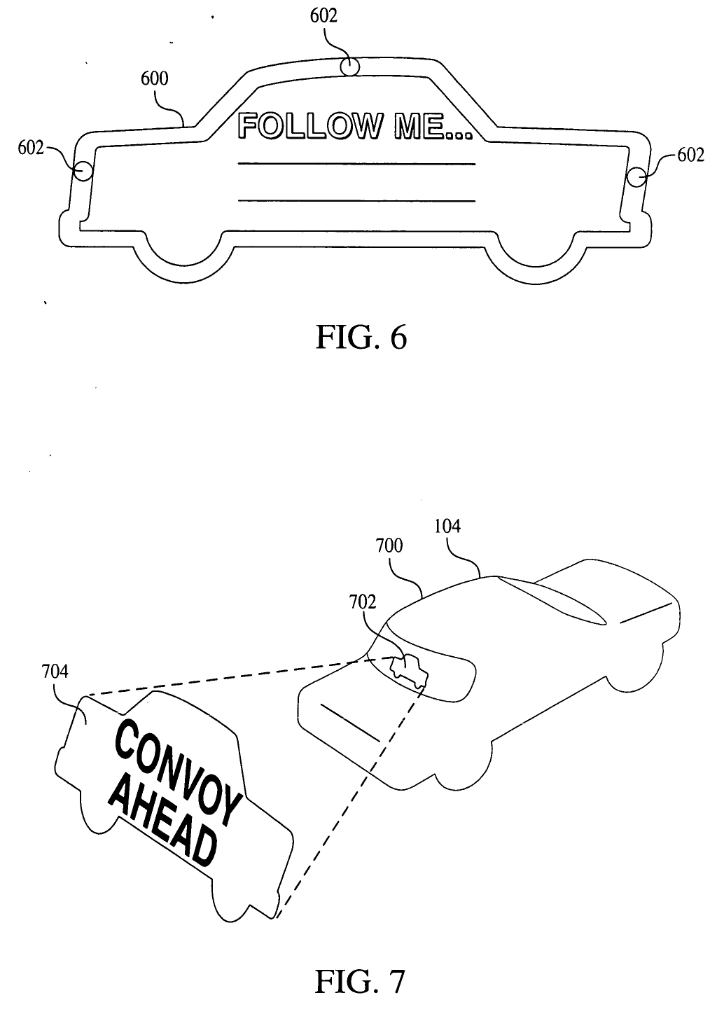

FIG. 6 is a plan view of an inside the vehicle embodiment 600. This embodiment has the shape, colors, and indicia of the magnetic sign embodiments. In addition, this embodiment has arrayed about the perimeter of the front of the sign one or more suction cups 602. This embodiment is attached by the suction cups to the inside of side, rear or front windows. Any suitable lightweight, resilient, material may be used for this embodiment, such as sheet plastic. This embodiment may be rolled into a cylinder to facilitate storage.

FIG. 7 is a perspective view of a projector image embodiment 700. Visible in FIG. 7 is a terminal vehicle 104. This vehicle has a projector 702 in the rear window which projects an image 704 on the pavement behind the vehicle. The image 704 has a shape and indicia 706 which indicates the existence of a convoy and the position of the vehicle in the convoy. A suitable projector image system is that disclosed in U.S. Pat. No. 6,733,134. incorporated herein by reference.

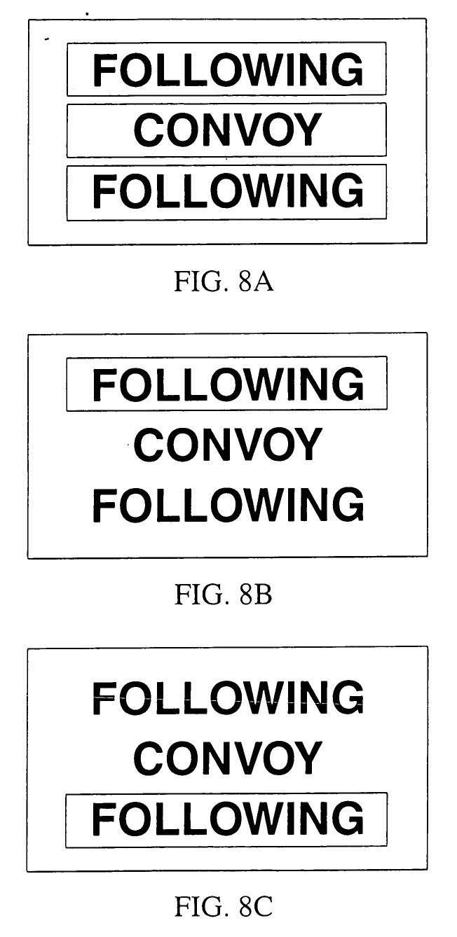

FIG. 8A, 8B and 8C are plan views of an illuminated sign embodiment 800. In this embodiment, indicia are illuminated by individual light bulbs 802. In FIGS. 8A, 8B, and 8C the non-illuminated bulbs are indicated by a border. The bulbs may be selectively illuminated in order to convey different information concerning the convoy. In FIG. 8A none of the bulbs in the sign is illuminated. In FIG. 8B the top line of bulbs 802 is not illuminated, while the middle line 804 and bottom line 806 are illuminated. FIG. 8B thus shows a sign with the indicia “CONVOY FOLLOWING.” The sign illustrated in FIG. 8B is used as the front indicator of a leading vehicle in a convoy. In FIG. 8C the bulbs in the bottom line 806 are not illuminated while those in the middle line 804 and top line 802 are illuminated. FIG. 8C thus shows a sign with the indicia “FOLLOWING CONVOY.” The illumination illustrated in FIG. 8C would be used as the rear indicator of a terminal vehicle in a convoy. Any suitable means of selectively illuminating the indicia of this embodiment may be used. Transparent inserts bearing indicia which are illuminated by lights behind inserts may be used.

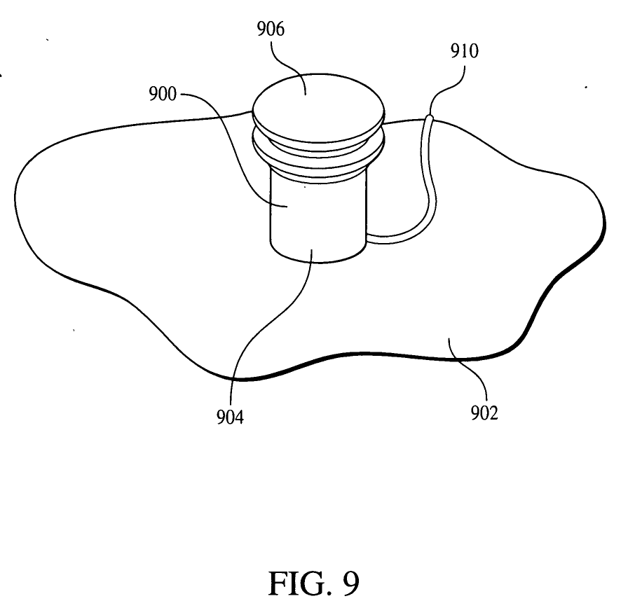

FIG. 9 is a perspective view of an illuminated beacon embodiment 900. An illuminated beacon is a specifically colored light visible from ahead, the side, or behind the vehicle and may be mounted inside the vehicle, or outside, such as on the roof. The color of the beacon is one which has no other significance with respect to highway traffic. Suitable colors for beacons, for example, would be brown, violet, or pink. The illuminated beacon embodiment is especially suitable for night use. The beacon in FIG. 9 is shown attached to a shelf 902 at the rear window of a vehicle. Visible in FIG. 9 is the base 904, crystal 906 which houses the bulb (not visible in FIG. 9), and power cord 910 of the beacon 900. Power is provided by the vehicle power system, with access, for example, at the cigarette lighter. Alternatively, the beacon may have an independent battery power supply. Beacons also may be mounted on the dashboard for indicating the existence of a convoy from the front window, or for viewing from the side windows, or on the top of the vehicle roof.

It will be apparent to those skilled in the art that the examples and embodiments described herein are by way of illustration and not of limitation, and that other examples may be used without departing from the spirit and scope of the present invention, as set forth in the appended claims.

I claim:

1. A system for indicating the status of a vehicle on the road with respect to its place in a convoy comprising:
an indicator visible from the front, rear, or side of the vehicle, the indicator warning of the existence of the convoy and indicating the position of the vehicle in the convoy.

2. A system for indicating the status of a vehicle on the road with respect to its place in a convoy comprising:
a first indicator visible from the front of the leading vehicle in the convoy,
the first indicator warning of following vehicles in the convoy and showing the status of the vehicle as the leading vehicle in the convoy,
a second indicator visible from the side of a vehicle intermediate in the convoy,
the second indicator warning of the existence of the convoy and showing the status of the vehicle as an intermediate vehicle in the convoy, and
a third indicator visible from the rear of the terminal vehicle in the convoy,
the third indicator warning of the existence of the convoy and showing the status of the vehicle as the terminal vehicle in the convoy.

3. The system of claim 1 wherein the indicator is a magnetic sign.

4. The system of claim 3 wherein the magnetic sign further comprises a personalized message.

5. The system of claim 3 wherein the magnet sign bears the indicia FOLLOW ME . . . GETTING THERE ALL TOGETHER or CONVOY IN PROGRESS.

6. The system of claim 1 wherein the indicator is a flag.

7. The system of claim 1 wherein the indicator is a sign mounted inside the vehicle and visible through the vehicle window.

8. The system of claim 1 wherein the indicator is a pattern projected on the road before, behind, or beside the vehicle by a projector borne by the vehicle.

9. The system of claim 1 wherein the indicator is an illuminated sign having illuminated indicia.

10. The system of claim 9 wherein the illuminated sign bears three lines, the top line with the indicia FOLLOWING, the middle line with the indicia CONVOY, the bottom line with the indicia FOLLOWING.

11. The system of claim 10 wherein the leading vehicle of a convoy bears an illuminated sign with the middle and bottom lines illuminated.

12. The system of claim 10 wherein an intermediate vehicle of a convoy bears an illuminated sign with the middle line illuminated.

13. The system of claim 10 wherein the terminal vehicle of a convoy bears an illuminated sign with the top and middle lines illuminated.

14. The system of claim 1 wherein the indicator is an illuminated light beacon.
